(19) United States
(12) Patent Application Publication
(10) Pub. No.: US 2018/0030272 A1
(43) Pub. Date: Feb. 1, 2018

(54) Composition comprising polyamide 66 and a polyamide chosen from the group consisting of: polyamide 610, polyamide 1010 and polyamide 1012

(71) Applicant: RHODIA OPERATIONS, Paris (FR)

(72) Inventors: Yeong-Chool YU, Seoul (KR); Jin-Kyung JUNG, Seoul (KR)

(21) Appl. No.: 14/878,607

(22) Filed: Oct. 8, 2015

Related U.S. Application Data
(63) Continuation of application No. 14/345,080, filed on Mar. 14, 2014, now abandoned.

(30) Foreign Application Priority Data
Sep. 21, 2011 (FR) 1158396

(51) Int. Cl. C08L 77/06

(52) U.S. Cl. CPC C08L 77/06; C08L 2205/02

(57) ABSTRACT

Composition comprising polyamide 66 and a polyamide chosen from the group consisting of: polyamide 610, polyamide 1010 and polyamide 1012. The present invention concerns a composition comprising at least polyamide 66 and a polyamide chosen from the group consisting of: polyamide 610, polyamide 1010 and polyamide 1012; and optionally fillers and/or additives. Such a composition has good chemical resistance, in particular to chlorides and cooling fluids.

The present invention relates to a composition comprising at least polyamide 66 and a polyamide selected from the group consisting of: polyamide 610, polyamide 1010 and polyamide 1012; and optionally fillers and/or additives. A composition of this kind exhibits effective chemical resistance, particularly with respect to chlorides and to cooling fluids.

The properties over which there is often a desire to exert control for a polyamide material intended for shaping by techniques such as injection molding, gas injection molding, extrusion, and extrusion blow molding include stiffness, impact resistance, dimensional stability, especially at relatively high temperature, low contraction after shaping, a capacity to be painted by a variety of processes, surface appearance, and density. Within certain limits, these properties can be controlled by the choice of a polyamide or by the addition to the polyamide of compounds of various kinds, such as fillers and/or additives. In this latter case, the systems are referred to as polymeric compositions. The choice of a material for a given application is generally guided by the level of performance required in terms of certain properties, and by the cost thereof. New materials are always being sought that have the ability to meet a specification in terms of performance and/or cost. Polyamide is, for example, a material which is widely used, particularly in the automobile industry sector.

Polyamide is a polymer which has chemical resistance, which is stable at high temperatures, and which may be blended with other types of polymers in order to modify their properties. Certain polyamides, however, such as polyamide 66, do not exhibit effective resistance to the chemical aggressions of external conditions, such as, for example, a high resistance to stress cracking when in halide solutions, or else the cooling fluids which are brought into contact with the polyamide articles.

There is a desire for a material based on polyamide 66 that exhibits better resistance to chemical products while featuring a good, modified balance of mechanical properties, in particular with sufficient impact resistance.

The applicant has demonstrated that the blend of a polyamide 66 with a shift in balance of terminal amine groups with a polyamide 610 allows the aforementioned disadvantages to be remedied. A formulation of this kind makes it possible, in particular, to have chemical resistance to metal halide solutions such as ZnCl₂ and to alkaline-earth metal halide solutions such as CaCl₂, or else the cooling fluids which are brought into contact with polyamide articles.

CaCl₂ is used, in particular, in refrigeration units, for road salting in severe cold weather, or in cements. Cooling fluids are often composed of water with an additive such as ethylene glycol or propylene glycol, which allows an increase in the boiling temperature and/or an increase in the frost resistance of the fluid.

The present invention accordingly provides primarily a composition obtainable by blending at least:

(a) a polyamide 66, the amount of terminal amine groups being greater than the amount of terminal acid groups;

(b) a polyamide selected from the group consisting of: polyamide 610, polyamide 1010 and polyamide 1012; and

(c) reinforcing or bulking fillers.

The invention also relates to a method for producing a composition, which comprises blending at least:

(a) a polyamide 66, the amount of terminal amine groups being greater than the amount of terminal acid groups;

(b) polyamide selected from the group consisting of: polyamide 610, polyamide 1010 and polyamide 1012; and

(c) reinforcing or bulking fillers.

The invention likewise relates to the use of a composition obtainable by blending at least:

(a) a polyamide 66, the amount of terminal amine groups being greater than the amount of terminal acid groups;

(b) polyamide selected from the group consisting of: polyamide 610, polyamide 1010 and polyamide 1012; and

(c) reinforcing or bulking fillers, for producing articles exhibiting enhanced chemical resistance.

The invention likewise relates to the use of a composition obtainable by blending at least:

(a) a polyamide 66, the amount of terminal amine groups being greater than the amount of terminal acid groups;

(b) polyamide selected from the group consisting of: polyamide 610, polyamide 1010 and polyamide 1012; and

(c) reinforcing or bulking fillers, for increasing the chemical resistance of an article obtained from said composition.

Polyamides 66, 610, 1010 and 1012 are described comprehensively in the literature, particularly in Nylon Plastics Handbook by M. I. Kohan; Hanser, 1995. Polyamide 66 is understood to mean, in particular, a polyamide comprising at least 80% by mass of hexamethylene adipamide units. Polyamide 610 is understood to mean, in particular, a polyamide comprising at least 80% by mass of hexamethylene sebacamide units. Polyamide 1010 is understood to mean, in particular, a polyamide comprising at least 80% by mass of decamethylene sebacamide units. Polyamide 1012 is understood to mean, in particular, a polyamide comprising at least 80% by mass of decamethylene dodecamide units. These polyamides may therefore equally well be (co)polyamides. Polyamides 66 and 610 are generally blended hot, in particular by extrusion.

For polyamide 66, the amount of terminal amine groups is preferably greater than or equal to 50 meq/kg, more preferably greater than or equal to 70 meq/kg. The difference between the amounts of terminal amine groups and terminal acid groups is preferably greater than or equal to 5 meq/kg, more preferably greater than 10 meq/kg, in particular greater than or equal to 40 meq/kg.

The amounts of terminal amine groups and/or terminal acid groups are determined by potentiometric assays following dissolution of the polyamide. One method, for example, is described in “Encyclopedia of Industrial Chemical Analysis”, volume 17, page 293, 1973. The amounts of terminal amine groups (TAG) and/or terminal acid groups (TCG) may be determined by potentiometric assay following complete dissolution of the polyamide, in trifluoroethanol, for example, and addition of a strong base in excess. The basic species are then titrated with an aqueous solution of strong acid. The amount of chain transfer agent is calculated by the ratio between the molar amount added of chain transfer agent and the mass of polymer produced. The amount of chain transfer agent may also be determined by hydrolysis of the polyamide, followed by analysis by liquid chromatography.

A disequilibrated, amine-containing polyamide 66 may be obtained in a variety of ways known to the skilled person, such as, for example, during polymerization, depending on the stoichiometric disequilibrium of the diamine and diacid compounds, or else during extrusion, by addition of compounds producing a final disequilibrated, amine polyamide 66.

The composition preferably comprises from 20% to 70% by weight of polyamide selected from the group consisting of: polyamide 610, polyamide 1010 and polyamide 1012, with respect to the total weight of the composition. The composition comprises preferably from 40% to 80% by weight of polyamide selected from the group consisting of: polyamide 610, polyamide 1010 and polyamide 1012, with respect to the total weight of polyamide 66 and of polyamide selected from the group consisting of: polyamide 610, polyamide 1010 and polyamide 1012.

The composition comprises preferably from 15% to 60% by weight of polyamide 66, with respect to the total weight of the composition.

The composition according to the invention may further comprise reinforcing or bulking fillers. These fillers may be, for example, fibrous fillers and/or nonfibrous fillers.

As fibrous fillers mention may be made of glass fibers, carbon fibers, natural fibers, aramid fibers, and nanotubes, especially carbon nanotubes. Mention may be made, as natural fibers, of hemp and flax. Mention may in particular be made, among nonfibrous fillers, of all particulate or lamellar fillers and/or exfoliable or nonexfoliable nanofillers, such as alumina, carbon black, aluminosilicate clays, montmorillonites, zirconium phosphate, kaolin, calcium carbonate, diatomaceous earths, graphite, mica, silica, titanium dioxide, zeolites, talc, wollastonite, polymeric fillers, such as, for example, dimethacrylate particles, glass beads or glass powder.

It is perfectly possible according to the invention for the composition to comprise several types of reinforcing fillers. Preferably, the most widely used filler can be glass fibers, of the “chopped” type, in particular having a diameter of between 7 and 14 μm.

These fillers may have surface sizing, ensuring mechanical adhesion between the fibers and the polyamide matrix.

The concentration by weight of the reinforcing or bulking fillers is advantageously between 1% and 60% by weight, preferably between 15% and 50% by weight, with respect to the total weight of the composition.

The composition may also comprise additives conventionally used for the production of polyamide compositions. Thus, mention may be made of lubricants, flame retardants, plasticizers, nucleating agents, impact modifiers, catalysts, light and/or heat stabilizers, antioxidants, antistats, colorants, mattifying agents, molding aids or other conventional additives.

In particular, it is possible to add to the polyamide composition, agents that modify the impact strength. It is generally elastomeric polymers that can be used to this end. The agents that modify the toughness are generally defined as having an ASTM D-638 tensile modulus of less than approximately 500 MPa. Examples of suitable elastomers are ethylene/acrylic ester/maleic anhydride products, ethylene/propylene/maleic anhydride products or ethylene/propylene/diene monomer products (EPDMs) with optionally a grafted maleic anhydride.

Preference is given especially to impact modifiers comprising functional groups that are reactive with the polyamide. Mention may be made, for example, of terpolymers of ethylene, acrylic ester and glycidyl methacrylate, copolymers of ethylene and butyl ester acrylate, copolymers of ethylene, n-butyl acrylate and glycidyl methacrylate, copolymers of ethylene and maleic anhydride, styrene/maleimide copolymers grafted with maleic anhydride, styrene/ethylene/butylene/styrene copolymers modified with maleic anhydride, styrene/acrylonitrile copolymers grafted with maleic anhydride, acrylonitrile/butadiene/styrene copolymers grafted with maleic anhydride, and their hydrogenated versions. The proportion by weight of these agents in the total composition is in particular between 0.1% and 40%, preferably between 5% and 20%.

These fillers and additives may be added to the polyamide composition by the usual means appropriate to each filler or additive, such as, for example, during polymerization or in melt-blending.

The thermoplastic compositions are generally obtained by mixing the various compounds forming part of the composition, the thermoplastic compounds being in melted form. The process is performed at more or less high temperature and at more or less high shear force, according to the nature of the various compounds. The compounds can be introduced simultaneously or successively. Generally speaking, an extrusion device is used in which the material is heated, subjected to a shearing force, and conveyed. Devices of this kind are very well known to the skilled person. According to a first embodiment, all the compounds are melt-blended during a single operation, for example during an extrusion operation. It is possible, for example, to blend granules of the polymer materials, to introduce them into the extrusion device in order to melt them and to subject them to more or less high shearing. According to particular embodiments, premixes of some of the compounds may be made, before the final composition is prepared.

The compositions of the invention are generally obtained by mixing the various constituents with heating, as for example in a single-screw or twin-screw extruder, at a temperature sufficient to maintain the polyamide resin in melt medium; or under cold conditions, in a mechanical mixer in particular. Generally, the blend obtained is extruded in the form of rods which are cut into pieces in order to form granules. The compounds can be added at any point in the process for the manufacture of the plastic, in particular by hot or cold blending with the plastic matrix. The addition of the compounds and additives can be carried out by addition of these compounds to the molten plastic matrix in the pure form or in the form of a concentrated mixture in a matrix, such as, for example, a plastic matrix.

The composition is preferably a molding composition, in the form of granules or powder, for example, which is used in particular to produce articles by a molding process or injection-molding process, in particular. The invention therefore likewise relates to a method for producing plastics articles, employing the composition as described above. The composition according to the invention can be used in any process for forming plastics, such as, for example, molding processes, in particular injection molding, rotational molding, sintering or casting, or extrusion processes, such as extrusion/blow molding and film-forming, or also spinning processes. The invention thus also relates to processes for the manufacture of molded or extruded articles by forming a composition of the invention.

The formulation may be used in particular for producing articles intended for recovering or conveying fluids, such as gases or liquids, such as, for example, tubes, conduits, or reservoirs. These articles may be single-layer or multilayer articles. The formulation of the invention may be used in particular to form one of these layers of the multilayer articles, in combination, for example, with other layers made from a variety of possible polymers.

A specific language is used in the description, so as to allow the principle of the invention to be readily understood. Nevertheless, it should be understood that no limitation on the scope of the invention is envisaged by the use of this specific language. Modifications, improvements and refinements can in particular be envisaged by a person conversant with the technical field concerned on the basis of his own general knowledge. The term “and/or” includes the meanings and, or and all the other possible combinations of the elements connected to this term. Other details or advantages of the invention will become more clearly apparent in the light of the examples given below purely by way of indication.

### EXPERIMENTAL PART

The compounds used are as follows:
A-1: Technyl 26A polyamide 66, manufactured by Rhodia, having a IV of 128 mL/g (ISO 307/formic acid) and a terminal acid group concentration of 81.7 meq/kg and a terminal amine group concentration of 48.2 meq/kg.
A-2: Technyl polyamide 66, manufactured by Rhodia, having a IV of 150 mL/g (ISO 307/formic acid) and a terminal acid group concentration of 32.4 meq/kg and a terminal amine group concentration of 74.8 meq/kg.
B: polyamide 610 having a relative viscosity of 2.8 (measured with 1% by weight in sulfuric acid at 23° C.) and a melting point of 218° C.
B2: polyamide 1010 having a relative viscosity of 2.5 (measured with 1% by weight in sulfuric acid at 23° C.) and a melting point of 199.6° C.
C: E glass fibers 4.5 mm in length
Additives comprising antioxidants and lubricants

The compositions are produced by blending the compounds in a twin-screw extruder (internal diameter 30 mm; L/D=30). The temperature profile of the extruder is between 260 and 280° C. The extrusion speed is between 250 and 300 rpm under a vacuum of 50-70 cm Hg.

The pellets obtained and after drying are shaped in an Engel injection molding press with a compressive force of 80 tonnes and an injection volume of 189.44 cc. The temperature of the barrel is 280° C. and the temperature of the mold is 80° C. The cycle of injection and cooling is approximately 15 seconds. Different specimens were produced according to the tests to be carried out.

The formulations are tested and the results are reported below:

### Example 1: Resistance to CaCl₂

The samples were placed in an aqueous solution comprising 30% by weight of CaCl₂ at 130° C. for 960 hours, and the results are reported in table 1 below:

TABLE 1

| | Unit | C1 | C2 | 1 | 2 |
|---|---|---|---|---|---|
| A-1 | % | 64.0 | 33.0 | — | — |
| A-2 | % | — | — | 33.0 | 33.0 |
| B | % | — | 31.0 | 31.0 | — |
| B2 | % | — | — | — | 31.0 |
| C | % | 35.0 | 35.0 | 35.0 | 35.0 |
| Additives | % | 1.0 | 1.0 | 1.0 | 1.0 |
| Breaking strength | (ASTM D-638) | 206.0 | 201.0 | 199.0 | 173.7 |
| Initial | MPa | | | | |
| Breaking strength | (ASTM D-638) | 87.6 | 120 | 131 | 116.1 |
| After 960 hours | MPa | | | | |
| Retention | % | 42.5 | 59.7 | 65.8 | 66.8 |

Furthermore, dumbbell specimens are subjected to cycles of 4 hours in a chamber at a pressure of 19 MPa and 100° C. The samples are sprayed 3 times daily with an aqueous solution comprising 50% by weight of CaCl₂ (5 ml/day). One of the ends of the samples is subjected to stress by a 660 g weight. Cracks are observed on the surface of the samples after 3 cycles for composition C1, after 24 cycles for composition C2, and only after 96 cycles for composition 1.

### Example 2: Resistance to LLC

The samples were placed in an LLC cooling fluid containing 50% by weight of water and 50% by weight of ethylene glycol for 960 hours, and the results are reported in table 2 below:

TABLE 2

| | Unit | C1 | 1 |
|---|---|---|---|
| A-1 | % | 20.0 | — |
| A-2 | % | — | 20.0 |
| B | % | 46.3 | 46.3 |
| C | % | 33.0 | 33.0 |
| Additives | % | 0.7 | 0.7 |
| Breaking strength | (ASTM D-638) | 187.3 | 181.0 |
| initial | MPa | | |
| Breaking strength | (ASTM D-638) | 84.5 | 91.7 |
| After 504 hours | MPa | | |
| Retention | % | 45.1 | 50.7 |
| Breaking strength | (ASTM D-638) | 74.6 | 80.7 |
| After 700 hours | MPa | | |
| Retention | % | 39.8 | 44.6 |

It should be noted that a formulation similar to formulation 1 but comprising 46.3 of polyamide B2 in place of B produces a retention of the breaking strength of 59.7% after 900 hours.

### Example 3: Mechanical Properties

The Izod impact strength was measured in accordance with the standard ASTM D 256 with the formulations C1, C2 and C1 from example 1. 10.3 KJ/m² are obtained for formulation C1, 16.8 KJ/m² for formulation C2, and 18.6 KJ/m² for formulation 1; moreover, the other properties of elongation at break, HDT, and flexural strength were equivalent between the different formulations.

1-11. (canceled)

12. A composition comprising:
(a) 15-60% by weight of a polyamide 66, the amount of terminal amine groups being greater than the amount of terminal acid groups;
(b) 20-70% by weight of a polyamide selected from the group consisting of: polyamide 610, polyamide 1010 and polyamide 1012; and
(c) reinforcing or bulking fillers.

13. The composition as claimed in claim 12, wherein the polyamide 66 has an amount of terminal amine groups of greater than or equal to 50 meq/kg.

14. The composition as claimed in claim 12, wherein the difference between the amounts of terminal amine groups and terminal acid groups in the polyamide 66 is greater than or equal to 5 meq/kg.

15. The composition as claimed in claim 12, wherein the composition comprises fibrous fillers and/or nonfibrous fillers.

16. The composition as claimed in claim 12, wherein the composition comprises between 1% and 60% by weight of reinforcing or bulking fillers, with respect to the total weight of the composition.

17. A method for producing a composition, which comprises blending at least:
(a) 15-60% by weight of a polyamide 66, the amount of terminal amine groups being greater than the amount of terminal acid groups;
(b) 20-70% by weight of a polyamide selected from the group consisting of: polyamide 610, polyamide 1010 and polyamide 1012; and
(c) reinforcing or bulking fillers.

18. A method for producing a plastics article, comprising forming the plastics article comprising at least one composition as claimed in claim 12.

19. A method for making articles exhibiting enhanced chemical resistance, comprising forming the articles comprising a composition that comprises a blend of at least:
(a) 15-60% by weight of a polyamide 66, the amount of terminal amine groups being greater than the amount of terminal acid groups;
(b) 20-70% by weight of a polyamide selected from the group consisting of: polyamide 610, polyamide 1010 and polyamide 1012; and
(c) reinforcing or bulking fillers.

20. The method of claim 18, wherein the step of forming the at least one composition comprises molding, extruding, or spinning of the at least one composition.

21. The method of claim 19, wherein the step of forming the composition comprises molding, extruding or spinning of the composition.

22. The composition of claim 12 comprising 15-50% by weight of the reinforcing or bulking fillers.

23. The composition of claim 12, wherein the polyamide 66 has an amount of terminal amine groups of greater than or equal to 70 meq/kg.

24. The composition of claim 12, wherein the difference between the amounts of terminal amine groups and terminal acid groups in the polyamide 66 is greater than or equal to 40 meq/kg.
